(19) United States
(12) Patent Application Publication
(10) Pub. No.: US 2017/0345408 A1
(43) Pub. Date: Nov. 30, 2017

(54) Active Noise Reduction Headset Device with Hearing Aid Features

(71) Applicant: EM-TECH. Co., Ltd., Busan (KR)

(72) Inventors: Choong Sheek Hong, Gyeonggi-do (KR); Joong Hak Kwon, Gyeongsangnam-do (KR); Seung Kiu Jeong, Gyeongsangnam-do (KR)

(21) Appl. No.: 15/606,632

(22) Filed: May 26, 2017

(30) Foreign Application Priority Data
May 27, 2016 (KR) 1020160065934

(51) Int. Cl. G10K 11/178; H04R 25/00

(52) U.S. Cl. CPC G10K 11/1788; H04R 25/65; H04R 25/50; G10K 2210/1081

(57) ABSTRACT

A headset device with active noise reduction includes a housing configured to be mounted near or in a human ear, a speaker unit equipped within the housing and configured to emit a sound signal, one or more microphone units configured to collect ambient sound and a signal processor electrically connected to the one or more microphone units. The signal processor is configured to selectively operate either in a hearing aid mode in which ambient sound coming in from the outside through the one or more microphone units is emitted, or in a noise reduction mode in which ambient sound coming in from the outside is inverted and the inverted ambient sound is emitted through the speaker unit to reduce the ambient sound. A corresponding method of operating the headset device is also provided.

### PRIORITY CLAIM

The present application claims priority to Korean Patent Application No. 10-2016-0065934 filed on 27 May 2016, the content of said application incorporated herein by reference in its entirety.

### TECHNICAL FIELD

The present invention relates to a headset device with active noise reduction, and more particularly to an active noise reduction headset device which can switch to a hearing aid mode in which outside sound is picked up and directed into the ear or amplified to make it easy to hear.

### BACKGROUND

With the widespread availability of personal portable electronics such as smartphones, headset devices that can be worn on a human body in the form of earphones or headphones are widely used. Such a headset device is connected by wires or wirelessly to external devices such as portable electronics, and allows the wearer to hear an audio signal from a media file being played, such as music or a movie. Headset devices often come with a microphone to transmit the wearer's voice signal to a connected external device.

Portable electronics and headset devices are usually used outdoors. For this reason, ambient noises from the outside world may make the user experience worse. That is, when the user is listening to music or a movie through a headset device, noises from passing cars, people talking nearby, passing subway trains, etc. may distract the user from the music or movie. Headset devices with noise reduction are being introduced to improve the user experience. Earlier noise reduction headset devices were in the form of in-ear type earphones or in the form of enclosed headphones that completely cover the ears. That is, they are passive devices that physically block outside noise from reaching the ears.

Recently, active noise reduction headsets have been introduced to further improve noise reduction. Active noise reduction, which is distinct from traditional passive noise reduction which physically blocks out noise, comprises a process of analyzing outside sound and/or a process of generating a specific sound. Active noise reduction is achieved through various signal processing algorithms, and the most typical among them is negative feedback using an inverted signal. In this method, when the user hears outside sound through a microphone, a sound with inverted phase to the original sound is emitted through a headset. This significantly reduces outside sound. U.S. Pat. No. 4,985,925 and U.S. Unexamined Patent Application No. 2016-0063986 discloses such active noise reduction headsets.

The traditional noise reduction headsets explained above still have several problems to be overcome. Firstly, noise reduction headset devices block out outside sound, thus making it difficult for the user to perceive emergency situations through their sense of hearing. Especially, active noise reduction headsets can block high-volume sounds, like honking cars or screaming, as they provide excellent noise reduction performance. Moreover, when someone speaks to the user, the user may not be able to perceive it. Even if they do, they need to take off the headset to carry on the conversation with that person. In loud, noisy environments, like construction sites or factories, people often find it difficult to talk to one another even at close range, so there is a need for a means of making conversations easier.

### SUMMARY

An object of the present invention is to provide a headset device which has a noise reduction mode and additionally has a hearing aid mode in which outside sound is amplified to make it easy to hear.

Another object of the present invention is to provide a headset device which recognizes external situations and automatically switches between the noise reduction mode and the hearing aid mode.

Yet another object of the present invention is to provide a headset device which recognizes sound the user needs to hear, such as voices, honking car horns, or alarms coming from the outside, and amplifies it to make it easy to hear.

According to an aspect of the present invention for achieving the above objects, there is provided a headset device with active noise reduction comprising: a housing that is mountable near or into a human ear; a speaker unit equipped within the housing and capable of emitting a sound signal; one or a plurality of microphone units for collecting ambient sound; and a signal processor electrically connected to the microphone unit(s), wherein the signal processor selectively operates, either in a hearing aid mode in which ambient sound coming in from the outside through the microphone unit(s) is emitted, or in a noise reduction mode in which ambient sound coming in from the outside is inverted and the inverted ambient sound is emitted through the speaker unit to reduce that ambient sound.

In some embodiments, the signal processor, when in the hearing aid mode, isolates a sound of interest from incoming ambient sounds, amplifies the sound of interest, and emits the amplified sound of interest through the speaker unit.

In some embodiments, the signal processor automatically switches from the noise reduction mode to the hearing aid mode upon detecting a sound of interest from ambient sounds coming in from the outside through the microphone unit(s).

In some embodiments, the signal processor automatically switches from the noise reduction mode to the hearing aid mode upon detecting a sound of interest from ambient sounds coming in from the outside through the microphone unit(s).

In some embodiments, the sound of interest is a human voice.

In some embodiments, the active noise reduction headset device comprises a display means for externally displaying whether the signal processor is in the hearing aid mode or in the noise reduction mode.

In some embodiments, the signal processor automatically switches from the hearing aid mode to the noise reduction mode if an external device connected to the active noise reduction headset device is playing media.

In some embodiments, the signal processor automatically switches from the noise reduction mode to the hearing aid mode if an external device connected to the active noise reduction headset device stops the playback of media.

According to the present invention, there is provided a headset which actively reduces noise and allows the user to hear outside sound comfortably without taking off the headset.

Furthermore, according to the present invention, there is provided a headset which enables seamless communications in noisy environments by amplifying sounds the user needs to hear, such as voices, honking car horns, or alarms, so that the user can hear better.

Furthermore, according to the present invention, there is provided a headset which recognizes external situations and automatically switches between a noise reduction mode and a hearing aid mode, without further control from the user, thus making it convenient to use.

Those skilled in the art will recognize additional features and advantages upon reading the following detailed description, and upon viewing the accompanying drawings.

### BRIEF DESCRIPTION OF THE DRAWINGS

FIG. 1 is a block diagram of an active noise reduction headset device according to an embodiment of the present invention.

FIG. 2 is a flowchart of a method of operation of an active noise reduction headset device according to an embodiment of the present invention.

FIG. 3 is a flowchart of a method of operation of an active noise reduction headset device according to another embodiment of the present invention.

FIG. 4 is a flowchart of a method of operation of an active noise reduction headset device according to yet another embodiment of the present invention.

### DETAILED DESCRIPTION

Hereinafter, a preferred embodiment of an active noise reduction headset device according to the present invention will be described in detail with reference to the accompanying drawings.

FIG. 1 is a block diagram of a configuration of an active noise reduction headset device according to an embodiment of the present invention. The active noise reduction headset device according to the embodiment of the present invention may comprise a microphone unit 100, a signal processor 200, a speaker unit 300, a terminal unit 400, and a display means 500. One or a plurality of microphone units 100 may be provided, and connected to the signal processor 200. Of course, this connection means an electrical wired or wireless connection but does not necessarily mean a physical connection. The microphone unit 100 collects external audio signals—that is, ambient sounds coming from around the microphone unit 100. Also, the microphone unit 100 may collect the voice of the wearer of the active noise reduction headset device. If a plurality of microphone units 100 are provided, some of them may be installed to collect ambient sounds, and the others may be installed to collect the voice of the wearer. The microphone unit 100 may be a microphone, for example.

The microphone unit 100 sends collected sound signals, i.e., ambient sounds or voices, to the signal processor 200. The signal processor 200 may send the received sound signals to the terminal unit 400 or, if necessary, may use them to produce phase-inverted signals for active noise reduction. For example, the wearer's voice received by the signal processor 200 may be sent to the terminal unit 400 directly or via signal processing by the signal processor 200, and ambient sound may be converted to a phase-inverted signal for noise reduction. However, in some embodiments, the wearer's voice signals may be transmitted directly to the terminal unit 400 from the microphone unit 100, without passing through the signal processor 200. The signal processor 200 may be a microprocessor, for example. Moreover, the signal processor 200 may control the operation of the active noise reduction headset device of this embodiment, and transmit a control signal for controlling a connected external device.

The terminal unit 400 serves to connect the active noise reduction headset device of this invention and an external device, e.g., a smartphone or tablet PC. The terminal unit 400 may be, for example, a connection terminal for physically connecting to an external device. Alternatively, the terminal unit 400 may be a wireless communication module, such as a Bluetooth module, for wirelessly connecting to an external device. The active noise reduction headset device may receive an audio signal or control signal from an external device connected through the terminal unit 400. Moreover, the active noise reduction headset device may transmit voice received by the microphone unit 100 of the active noise reduction headset device to an external device or transmit a control signal to the external device to control the external device.

The speaker unit 300 emits various audio signals to deliver sound to the wearer of the active noise reduction headset device. These audio signals may be, for example, audio signals that are received through the terminal unit 400 and transmitted by an external device. That is, audio signals from media being played, such as music or video, may be received to deliver sound through the speaker unit 300. Alternatively, these audio signals may be phase-inverted signals generated by the signal processor 200 for active noise reduction. In this case, ambient sound and the phase-inverted signals may combine, and this greatly lowers the volume of the ambient sound, thus creating a noise reduction effect. It will be appreciated by those skilled in the art that a detailed method of active noise reduction using phase inversion, which is performed by the above-described signal processor 200, may be fully achieved through the use of a known method or algorithm. The speaker unit 300 may be accommodated in a housing (not shown), and the active noise reduction headset device may be preferably positioned near the wearer's ear when it is worn.

Besides, the active noise reduction headset device of this invention may comprise a power supply (not shown) for supplying operating power, especially to the signal processor 200 or the terminal unit 400. To this end, the power supply may comprise a rechargeable battery, for example. Alternatively, operating power may be supplied from an external device to the signal processor 200 through the terminal unit 400.

The signal processor 200 may selectively operate, either in a hearing aid mode in which ambient sound coming in from the outside through one or a plurality of microphone units 100 is directed to the speaker unit 300 and the speaker unit 300 outputs sound to the ear, or in a noise reduction mode in which ambient sound coming from the outside is inverted and the phase-inverted signal is emitted through the speaker unit 300 to deliver sound while reducing that ambient sound. For example, when the wearer wants to listen to music through an external device, the signal processor 200 may operate in the noise reduction mode. In this case, the speaker unit 300 may emit an audio signal coming in through the external device to deliver sound and, at the same time, may emit a signal with inverted phase to the ambient sound to reduce that ambient sound. Also, for example, when the wearer wants to hear ambient sound, the signal processor 200 may operate in the hearing aid mode. In this case, ambient sound coming in from the outside through the microphone unit 100 may be directly directed to the speaker unit 300 and the speaker unit 300 outputs into the wearer's ear. If an external device connected to the active noise reduction headset device is playing media, the ambient sound may be delivered, along with audio signals coming in through the external device, or only the ambient sound may be selectively delivered while the output of the audio signals coming in through the external device is stopped.

In some embodiments, the active noise reduction headset device of this invention may comprise a display means 500. The display means 500 may externally show at least which mode the signal processor 200, at least, is operating in. For example, the display means 500 may visually and externally show the operation mode at least by using an LED. In the hearing aid mode, the active noise reduction headset device of this invention allows the wearer to hear other people's voices coming from the outside, thus enabling the wearer to speak to other people while wearing it. However, without the display means 500, the person the wearer is talking to cannot clearly tell if the wearer of the active noise reduction headset device is hearing their voice or not, which may make that person less engaged in the conversation with the wearer. Thus, the operation mode of the active noise reduction headset device may be shown externally, that is, to the person the wearer is talking to, through the display means 500. In this way, the wearer can actively let the other person know that they can hear their voice.

When in the hearing aid mode, the signal processor 200 may emit ambient sound coming in from the outside directly through the speaker unit 300, as described above, or may selectively amplify a specific sound via signal processing and then emit it. For example, the signal processor 200 may isolate a human voice from ambient sound and amplify it so that the voice can be clearly heard. This can be achieved simply by increasing the volume of sounds in midrange frequencies in which human voice mostly falls, or through the use of various signal processing algorithms. Alternatively, signal processing may be done in such a way that only car honking sounds can be clearly heard. This also can be achieved simply by increasing the volume of sounds in frequencies (e.g., high-range frequencies) in which car honking sounds mostly fall.

Preferably, the signal processor 200 may selectively recognize a certain sound (hereinafter, “sound of interest”) the user needs to hear, out of ambient sounds coming in from the outside. For example, if human voice or car honking sound is of interest, the signal processor 200 may recognize in the hearing aid mode whether human voice or car honking sound is included in ambient sound or not, and then amplify the recognized sound of interest and emit it through the speaker unit 300, as described previously. According to the embodiment, the signal processor 200 may automatically switch to the hearing aid mode upon detecting a sound of interest while recognizing ambient sound in the noise reduction mode, and then selectively amplify that sound's source and emit it. The signal processor 200 may recognize the type of sound—for example, human voice or typical car honking sound—or details of sound—for example, a specific person's voice or a specific word. Such sound recognition can be achieved through analysis of volume and frequency components, by using traditional voice recognition technologies.

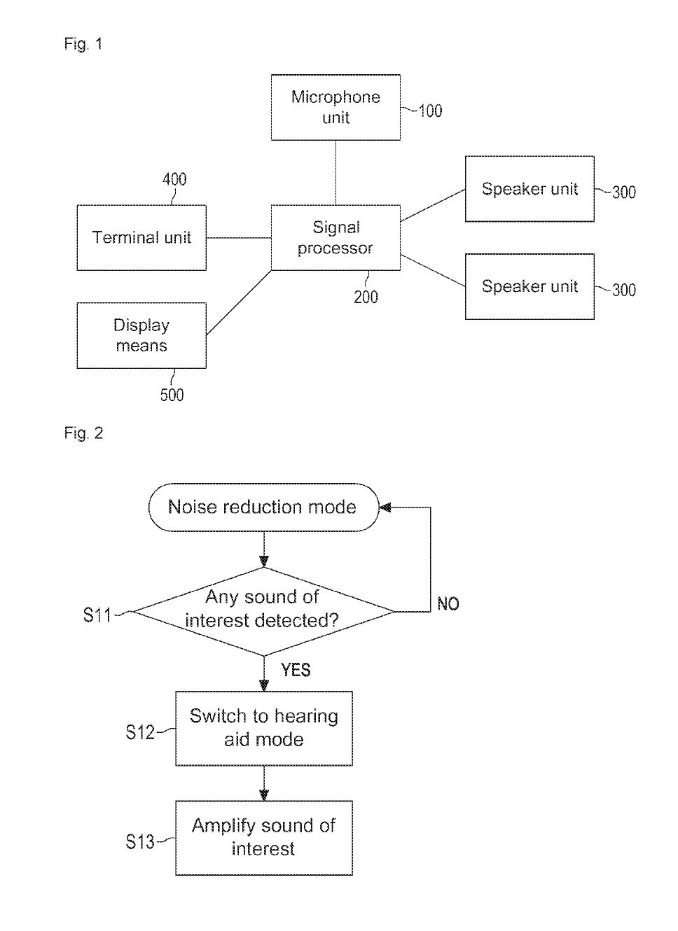

FIG. 2 is a flowchart of a method of operation of an active noise reduction headset device according to an embodiment of the present invention. The signal processor 200 monitors ambient noise entering the microphone unit 100 during the noise reduction mode and continuously detects any sound of interest (step S11). Upon detecting a sound of interest, the signal processor 200 automatically switches to the hearing aid mode (step S12) to deliver the ambient sound and, at the same time, amplifies that sound of interest via signal processing depending on the type of the detected sound of interest and emits the amplified signal through the speaker unit 300 (step S13).

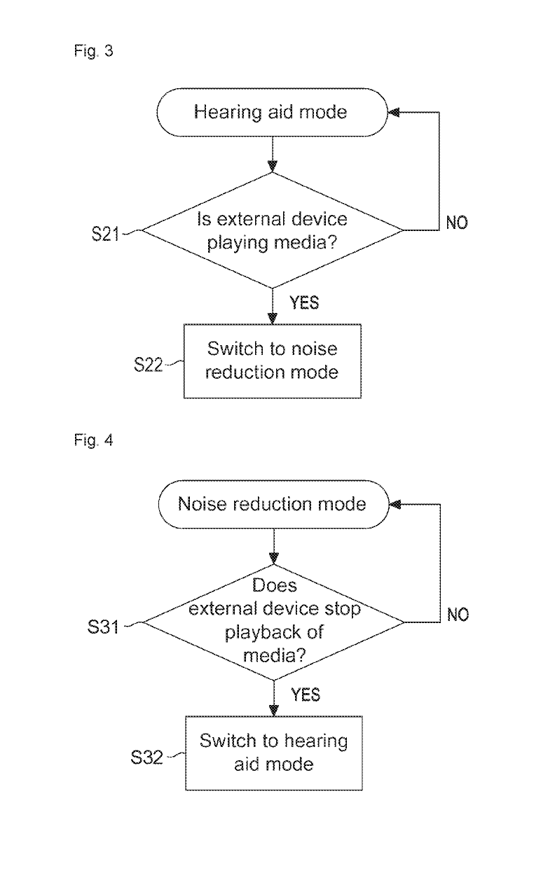

FIG. 3 is a flowchart of a method of operation of an active noise reduction headset device according to another embodiment of the present invention. The signal processor 200 continuously monitors during the hearing aid mode whether an external device connected to the active noise reduction headset device is playing media (music, video, etc.) (step S21). If the external device is playing media, the signal processor 200 recognizes this and automatically switches to the noise reduction mode (step S22). As described previously, in the noise reduction mode, the speaker unit 300 emits an audio signal from the media being played to deliver sound and, at the same time, emits a phase-inverted signal for ambient sound reduction to deliver sound, thereby enabling the user to enjoy the media file while reducing the ambient sound.

FIG. 4 is a flowchart of a method of operation of an active noise reduction headset device according to yet another embodiment of the present invention. The signal processor 200 continuously monitors during the noise reduction mode whether an external device connected to the active noise reduction headset device stops the playback of media (step S31). If the external device stops the playback of media, the signal processor 200 recognizes this and automatically switches to the hearing aid mode (step S32). As described previously, in the hearing aid mode, ambient sound coming in from the outside through the microphone unit 100 is directly directed to the speaker unit 300 and delivered into the wearer's ear through the speaker unit 300. Alternatively, the signal processor 200 may amplify a sound of interest via signal processing and emit it along with the ambient sound.

Advantages characteristic of the present invention will be clearly derived from the above-described embodiments. That is, an active noise reduction headset device according to some embodiments of the present invention may allow the user to enjoy media, with ambient noise reduced during the playback of the media through an external device, and if necessary, it may operate in the hearing aid mode to allow the user to hear ambient sound directly, without taking off the headset device, or to selectively amplify a sound of interest, such as voice, making it easy to hear. In some embodiments, the active noise reduction headset device may automatically switch from the noise reduction mode to the hearing aid mode, upon detecting an emergency situation or someone nearby speaking while the user is listening to media, with ambient noise reduced, and amplify speech or car honking sound to make it easy to hear, thereby enabling the listener to enjoy the media comfortably and cope with conversations or emergency situations. Furthermore, in some embodiments, the operation mode of the active noise reduction headset device may be shown externally and therefore the wearer can carry on a conversation with the other person without awkwardness while wearing the headset device. Furthermore, in some embodiments, if a media file is being played by a connected external device, the active noise reduction headset device of this invention may recognize this and automatically switch to the noise reduction mode, or inversely, if the playback of the media file is stopped, it may recognize this and automatically switch to the hearing aid mode, thus making it convenient to use and improving the user experience.

The above description has been made to help understanding of the present invention, and it should be noted that the scope of the claims of this invention is not limited to the specific embodiments described above.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A headset device with active noise reduction_{;} comprising:
a housing configured to be mounted near or in a human ear;
a speaker unit equipped within the housing and configured to emit a sound signal;
one or more microphone units configured to collect ambient sound; and
a signal processor electrically connected to the one or more microphone units,
wherein the signal processor is configured to selectively operate either in a hearing aid mode in which ambient sound coming in from the outside through the one or more microphone units is emitted, or in a noise reduction mode in which ambient sound coming in from the outside is inverted and the inverted ambient sound is emitted through the speaker unit to reduce the ambient sound.

2. The headset device of claim 1, wherein the signal processor, when in the hearing aid mode, is configured to isolate a sound of interest from incoming ambient sounds, amplify the sound of interest, and emit the amplified sound of interest through the speaker unit.

3. The headset device of claim 2, wherein the signal processor is configured to automatically switch from the noise reduction mode to the hearing aid mode responsive to detecting the sound of interest.

4. The headset device of claim 2, wherein the sound of interest is a human voice.

5. The headset device of claim 1, wherein the signal processor is configured to automatically switch from the noise reduction mode to the hearing aid mode responsive to detecting a sound of interest from ambient sounds coming in from the outside through the one or more microphone units.

6. The headset device of claim 1, further comprising a display configured to externally display whether the signal processor is in the hearing aid mode or in the noise reduction mode.

7. The headset device of claim 1, wherein the signal processor is configured to automatically switch from the hearing aid mode to the noise reduction mode if an external device connected to the headset device is playing media.

8. The headset device of claim 1, wherein the signal processor is configured to automatically switch from the noise reduction mode to the hearing aid mode if an external device connected to the headset device stops playback of media.

9. A method of operating a headset device with active noise reduction, the method comprising:
emitting a sound signal from a speaker unit equipped within a housing mounted near or in a human ear;
collecting ambient sound via one or more microphone units; and
selectively operating the headset device either in a hearing aid mode in which ambient sound coming in from the outside through the one or more microphone units is emitted, or in a noise reduction mode in which ambient sound coming in from the outside is inverted and the inverted ambient sound is emitted through the speaker unit to reduce the ambient sound.

10. The method of claim 9, wherein in the hearing aid mode the method further comprises:
isolating a sound of interest from incoming ambient sounds;
amplifying the sound of interest; and
emitting the amplified sound of interest through the speaker unit.

11. The method of claim 10, further comprising automatically switching from the noise reduction mode to the hearing aid mode responsive to detecting the sound of interest.

12. The method of claim 10, wherein the sound of interest is a human voice.

13. The method of claim 9, further comprising automatically switching from the noise reduction mode to the hearing aid mode responsive to detecting a sound of interest from ambient sounds coming in from the outside through the one or more microphone units.

14. The method of claim 9, further comprising externally displaying whether the headset device is in the hearing aid mode or in the noise reduction mode.

15. The method of claim 9, further comprising automatically switching from the hearing aid mode to the noise reduction mode if an external device connected to the headset device is playing media.

16. The method of claim 9, further comprising automatically switching from the noise reduction mode to the hearing aid mode if an external device connected to the headset device stops playback of media.
